(19) United States
(12) Patent Application Publication
(10) Pub. No.: US 2011/0101104 A1
(43) Pub. Date: May 5, 2011

(54) METHOD AND SOFTWARE FOR LABELING AN ELECTRONIC DEVICE

(76) Inventors: Timothy J. Flynn, Key Largo, FL (US); Geoffrey T. Brossard, Crystal Lake, IL (US); James Mayall, Carlsbad, CA (US)

(21) Appl. No.: 12/608,694

(22) Filed: Oct. 29, 2009

(51) Int. Cl. G06F 17/00; G06K 19/00

(52) U.S. Cl. 235/488; 715/273; 715/255; 235/487

(57) ABSTRACT

A method is provided for designing and printing a label that can be applies to an electronic device having a planar and/or a non-planar surface and a view screen, such as an iPod® electronic music player or other MP3 player, a personal digital assistant, or a cell phone. The method provides a label and electronic view screen image that both apply to the device and together give an appearance of a seamless cover on the electronic device.

### FIELD OF THE INVENTION

This invention is directed to designing and printing a label to be applied to an electronic device having a planar and/or a non-planar surface and a view screen, e.g., an iPod® electronic music player or other MP3 player, a personal digital assistant, or a cell phone.

### SUMMARY OF THE INVENTION

This invention provides a method of creating and printing a label image for a label for an electronic device, such as a portable media player, a cell/smart phone, a handheld game console, a personal digital assistant, an e-book reader, a calculator, or any other similar or suitable object. The method is desirably implemented on a data processor through a software program including data processor-executable instructions, stored on a readable medium, for carrying out or performing the method of this invention.

The invention provides a printed label for an outer surface of the device. The label can be a self-adhesive label printed with a custom image. The portion of the printed image that would fall within or otherwise cover the view screen of the device is converted to an electronic image that can be downloaded and displayed on the device. The uploaded and displayed portion of the original image can provide a wallpaper or screensaver that, in combination with the printed label, results in full display of the original image on the labeled device. The method of this invention provides an essentially seamless decorative cover for the electronic device by displaying an image using a combination of the view screen and a printed label adhered on the device housing.

The invention uses a software program to combine an electronic image chosen by a user with a template having dimensions that correspond with a label for the electronic device. The template includes a window corresponding to the view screen of the device. The user positions the image as desired within the template, and the portion of the electronic image that falls within the window is removed or copied and converted to a new electronic image suitable for uploading to the device. The image is printed onto a label assembly including a label that corresponds to the template and the device. When the label is placed on the device and the portion of electronic image is displayed on the view screen of the device, the label and the electronic image can be essentially combined to create the original image.

The method of this invention includes: positioning an electronic image within a label template displayed in a graphical user interface by a data processor, the label template including a window corresponding to the view screen or feature of the electronic device; and printing at least a portion of the electronic image on a label corresponding to the label template. A portion of the image within the window can also be used to generate a new electronic image for displaying on the view screen of the device.

The method of another embodiment of this invention includes the steps of: displaying a label template selected by a user in a graphical user interface generated by a data processor, the label template including a boundary corresponding to a label for the electronic device and a window within the boundary corresponding to a view screen of the electronic device; accessing an electronic image with the graphical user interface; positioning the electronic image with the label template displayed in the graphical user interface; generating a view screen electronic image from a portion of the electronic image positioned within the window for upload to the electronic device and display on the view screen; and printing a portion of the electronic image that positioned between the boundary and the window on the label.

Another embodiment includes creating a plurality of view screen electronic images that can be displayed randomly or sequentially, and desirably in a repeating manner, on the view screen of the electronic device. Another embodiment includes displaying a video on the view screen of the electronic device that corresponds to a label for the body of the device.

The invention also includes software for labeling an electronic device. The software is formed of code stored on a recordable medium and for execution on a data processor. The software includes: instructions for combining a label template and an electronic image within a graphical user interface, the label template including a boundary and a window within the boundary; commands for generating a view screen electronic image by extracting a section of the electronic image positioned within the window within the graphical user interface for upload to the electronic device and display on the view screen; and commands for sending at least a portion of the electronic image bordered by the boundary to a printer in communication with the data processor for printing.

### BRIEF DESCRIPTION OF THE DRAWINGS

These and other objects and features of this invention will be better understood from the following detailed description taken in conjunction with the drawings.

FIG. 1 is a perspective view of an electronic device without a label.

FIG. 2 is a perspective view of the electronic device of FIG. 1 with a label applied according to an embodiment of this invention.

FIG. 3 is a flow chart of labeling an electronic device according to an embodiment of this invention.

FIG. 4 is a representation of an electronic image used for explanation herein.

FIG. 5 illustrates a label template selection menu in a graphical user interface according to an embodiment of this invention.

FIG. 6 illustrates a label template according to an embodiment of this invention.

FIG. 7 illustrates the electronic image of FIG. 4 combined with the label template of FIG. 6 according to an embodiment of this invention.

FIGS. 8 and 9 illustrate an exemplary label assembly for use in the method of this invention.

FIG. 10 illustrates a second electronic image combined with the label template of FIG. 6 according to an embodiment of this invention.

FIG. 11 is a perspective view of the electronic device of FIG. 1 with a label applied with an embodiment of this invention showing a portion of the second electronic image created from FIG. 8.

### DETAILED DESCRIPTION OF THE INVENTION

This invention provides a method for labeling an electronic device, such as, but not limited to, a portable media player, a cell phone, a handheld game console, a personal digital assistant, a gps unit, an e-book reader, a laptop, a netbook, a calculator, or any other similar or suitable object. The invention also includes software for implementing the method of this invention, either manually by the user, automatically by a data processor, or desirably with a combination of manual and automatic steps. The method and software can be used to label objects and devices with or without view screens, but in a preferred embodiment the invention provides a combination paper label and electronic image for decorating a device having a view screen. The invention will be described herein below with reference to an IPOD® media player which includes a body and a view screen.

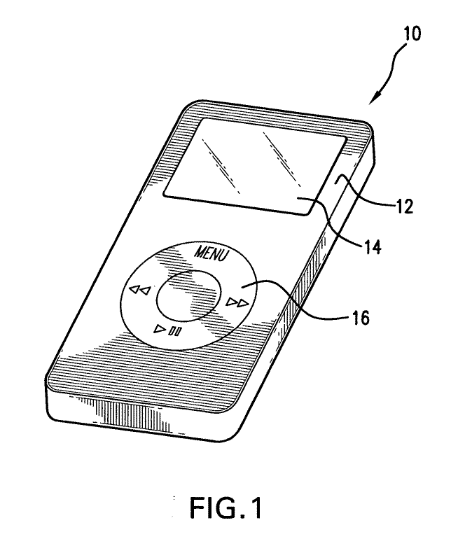

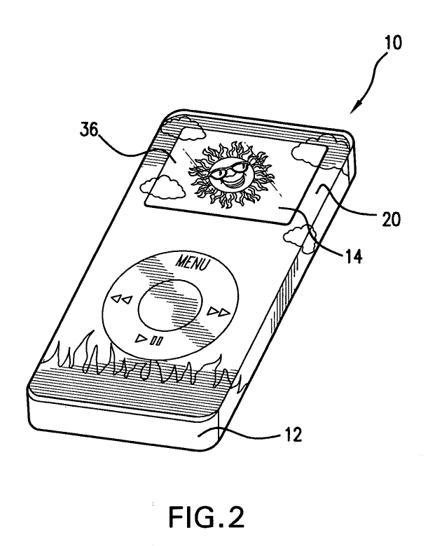

FIG. 1 shows a perspective view of one example of an electronic device 10, namely an IPOD® portable media device, without any label. FIG. 2 shows a perspective view of the electronic device 10 after being labeled with a decorative label 20 and screen image 36, provided according to an embodiment of the method of this invention. The electronic device 10 includes a body 12, a view screen 14 and an interface 16. Other types of electronic devices may not include both of the view screen 14 and the interface 16, such as in devices having a touch screen. In the embodiment of FIGS. 1-2, the interface 16 is a click wheel and a button. Other examples of electronic device interfaces include touch pads, keyboards, buttons, roller balls, headphone jacks and/or joysticks.

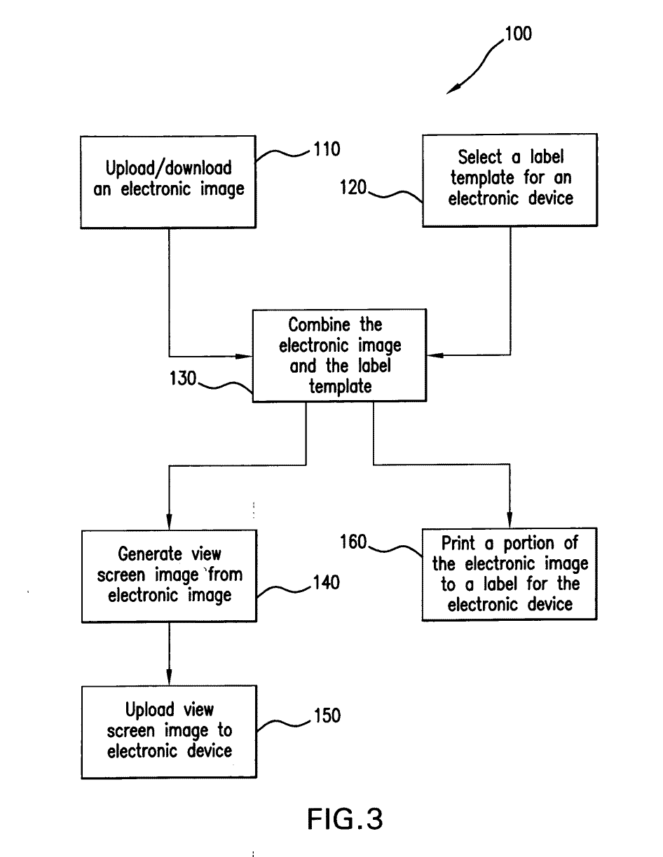

FIG. 3 is a flow chart 100 representing the steps of custom labeling a device with a view screen according to an embodiment of the method of this invention. In box 110, a user accesses an electronic image with a data processor. The user can access the electronic image in a variety of ways including, but not limited to, downloading a picture from a digital camera, opening a image file stored on a memory component (e.g., a CD, DVD, or hard drive) in combination with the data processor, scanning a picture using a scanner, and/or downloading a picture as an image file from a website. The electronic image to be used in labeling the device is desirably displayed on a screen or a monitor through a graphical user interface (GUI) upon accessing.

Box 120 of FIG. 3 represents a step of selecting a label template that corresponds to the device being labeled. The label template can be selected through a GUI, such as a window or dropdown menu listing the templates by devices. In an embodiment of this invention, a plurality of label templates are programmed into the program, with each of the label templates corresponding to a type of electronic device such as, but not limited to, an iPod®, a Zune®, an iPhone®, a Blackberry®, a Palm® or a Playstation Portable®. Each label template generally corresponds to a label for a particular device. The label template includes an outer boundary, a window within the boundary corresponding to the view screen, and desirably, but optionally, other window shapes corresponding to other device components such as interface components described above. The template list can be updated as needed to add new device templates, such as by downloading new templates from the Internet. In one embodiment of this invention, the software implementing the method allows a user to create a custom label template by manually entering the device dimensions into the program or by downloading a template created in another software program.

Box 130 represents a step of combining the label template and the electronic image. The image can be placed over the template, or the template can be placed over the image within a GUI. The outline of the template can be seen over or through the image, so that the user can position the image as desired with respect to the template. The image may be larger than the template, and can extend beyond the template or can be appropriately resized or scaled by the user. Conventional image editing tools, such as red eye reduction or color, brightness, and contrast controls can be provided through the software for the user to modify the image while combining the image with the template.

The portion of the image that is positioned within the view screen window of the template represents the portion of the image that can be displayed on the device view screen. Once the user has coordinated the image and the template to provide the desired placement for printing the label, the user actuates the actions illustrated by boxes 140 and 160.

After combining the electronic image with the label template in box 130, the method of this invention creates a view screen electronic image in box 140. The electronic image is created from the portion of the original image that is positioned by the user within the view screen window of the label template. The electronic image can be created by any suitable means. In one embodiment, the electronic image is created through a number of manual steps, such as manually cutting, copying, or otherwise saving the image portion within the template window. The image portion can be opened in another GUI or another program, manipulated if needed, and saved as an electronic image suitable for upload to the electronic device to be labeled. Desirably however, the creation of the uploadable view screen electronic image file is an automatic process that occurs upon the actuation by the user. The data processor desirably automatically removes or otherwise copies the image portion within the window and automatically creates a separate electronic image from the image portion. In one embodiment of the invention, the new view screen electronic image file is automatically sent to an upload queue within a software application used for uploading files to the electronic device. For example, the image portion for the IPOD® shown in FIG. 1 can be automatically sent to the iTunes program for uploading to the IPOD® in box 150.

The printing of a label for the device occurs in box 160, either sequentially or simultaneously to the step in box 140. The portion within the template window is destined for upload to the device, and at least the remaining portion of the image between the template window and template outer boundary is to be printed on a label for the device. The entire image, or to save toner simply the portion of the image between the view screen window and the template border, is sent to a printer queue and printed on a label of label assembly. The label has a shape formed by die cuts or other tearable lines of separation that corresponds to the template and the device to be labeled. The label is printed with the image and when removed corresponds to all or a portion of the body of the device that houses the view screen. The label can be printed with conventional printing techniques, such as using a laser or ink jet printer.

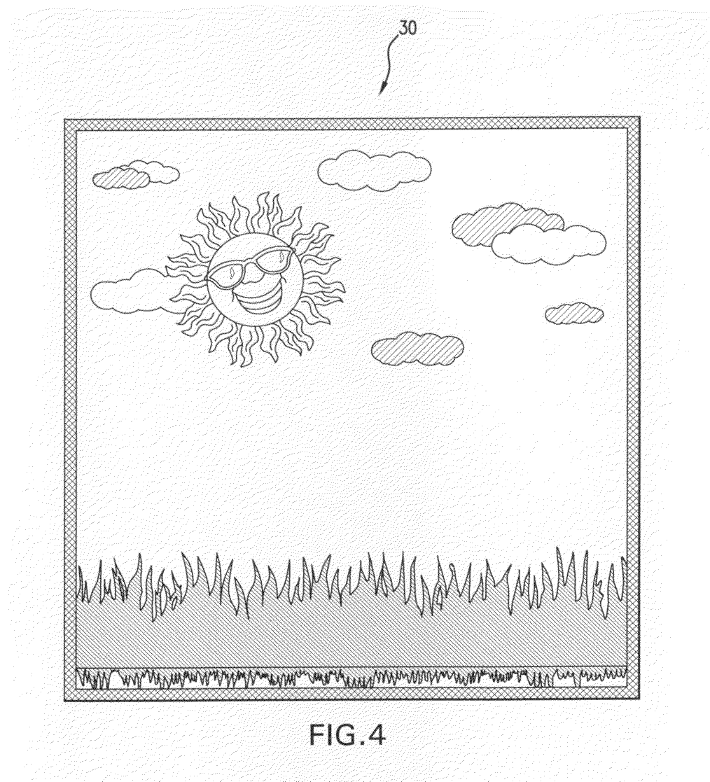

FIGS. 4-8 illustrate an example of labeling a device according to this invention. FIG. 4 shows an exemplary electronic image 30 to be used in labeling an electronic device such as shown in FIG. 1. The electronic image 30 includes a smiling sun which can be part of or added by the user to a background of clouds, sky, and grass. The electronic image 30 can be in any format including, but not limited to, a JPEG, a TIF, a PDF, or a GIF file.

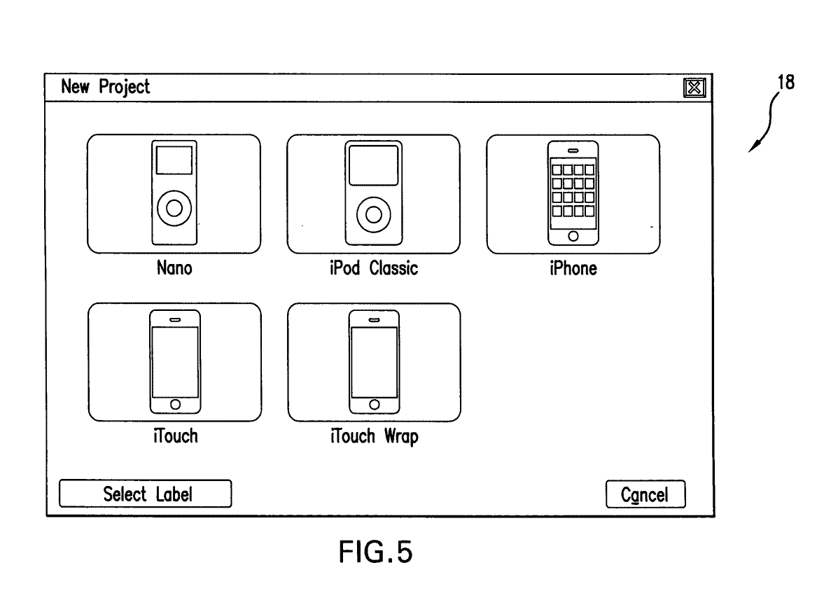

FIG. 5 is a GUI with a label template selection menu 18 listing a choice of five label templates for a new labeling project. As discussed above, the number of label templates can vary, and the software of this invention desirably includes templates for many different types of devices. As will be appreciated, the devices can be organized by manufacturer or brand to limit the number shown to the user at one time. The device label templates can also include more than one template for a device. As shown in FIG. 5, there are two options for the IPOD TOUCH®. The first is a front surface only label, and the second is a label that wraps around the device to cover the front, back, and sides.

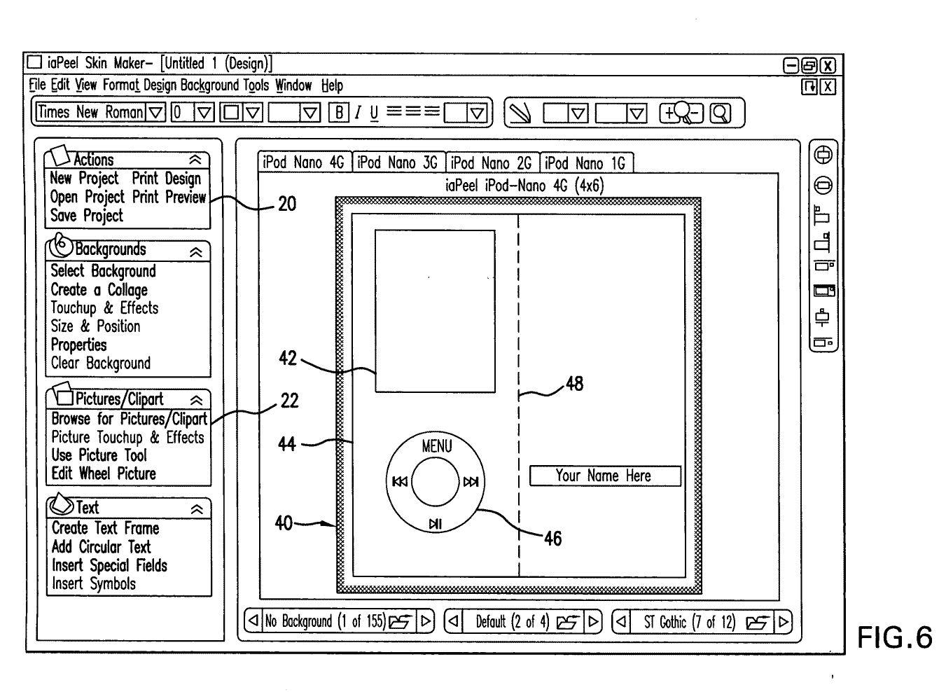

Upon selecting a device from the selection menu 18, the GUI of FIG. 6 opens and displays the selected label template 40. The label template 40 includes a form and/or lines that correspond to a label for the electronic device 10 shown in FIG. 1. The label template 40 includes a window 42, a boundary 44, and an interface shape 46. The window 42 corresponds to the view screen 14 of the electronic device 10. The boundary 44 corresponds to an overall shape of the label for the electronic device 10. The interface shape 46 corresponds to the interface 16 of the electronic device 10. Other interface shapes can optionally be included in templates for devices having additional interface components. As device labels commonly include cutouts for interface components, showing the label cutouts as interface shapes 46 on the device template 40 allows the user to see how the label and image will ultimately look on the device 10, particularly by showing image portions that may be removed as removable label shapes before the label is applied to the device. Label template 40 also includes an optional reference line 48 that corresponds to a fold line of the label for an edge of the body 12 of the electronic device 10. The reference line 48 can be useful for positioning the electronic image 30 with the label template 40 so that a user can identify where the label will be folded when applied to the body 12 of the electronic device 10. In another embodiment, the label template 40 may not include the window 42, the interface shape 46 and/or the reference line 48.

The GUI of FIG. 6 includes several menu boxes. Menu box 20 includes icons, buttons or links to actuate commands and/or open new GUI windows for beginning new or started projects and printing labels from the template 40. Menu box 22 includes icons buttons or links for accessing images for combining with the template 40. Several other menu boxes of various forms include various editing tools for the image 30 and/or template 40.

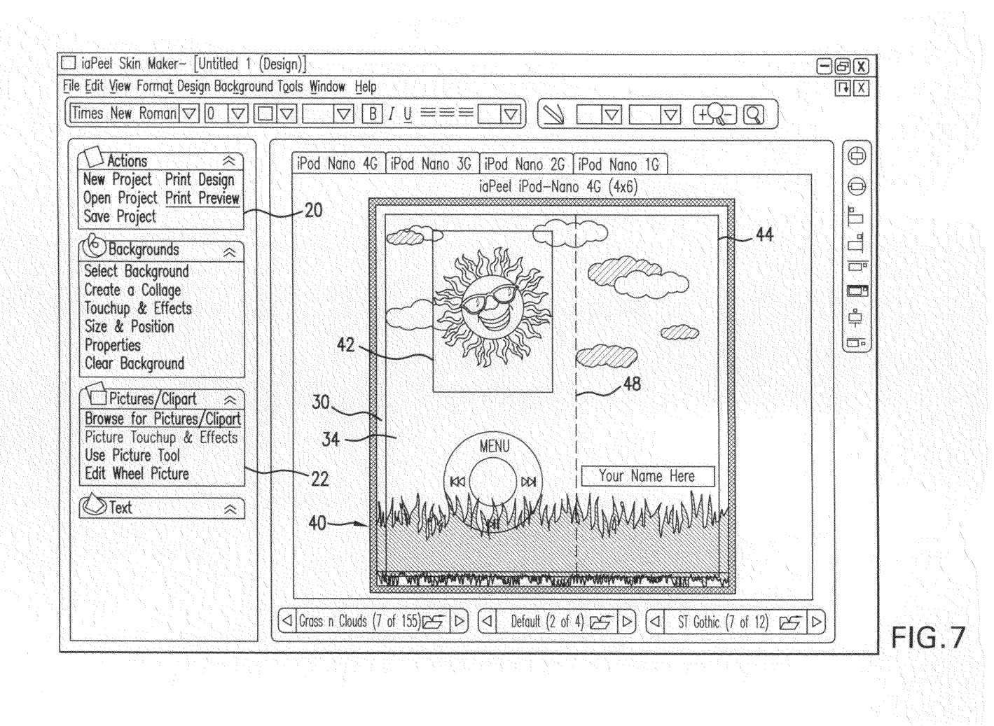

FIG. 7 shows an embodiment in which the electronic image 30 has been opened in the GUI through use of menu box 22. As can be seen in FIG. 7, both the template 40 and the image 30 are displayed when overlapped. The position of the label template 40 with respect to the electronic image 30 identifies which portions of the electronic image 30 can be copied to the view screen 14 of the device 10, printed to a label for adhering the body 12, and/or not used for either the label or the view screen of the electronic device 10. The label template 40 can be formed as several lines and placed over the image or as a semi-transparent mask positioned over the electronic image 30. Alternatively, the electronic image 30 can be positioned over the label template 40, such as by making the image semi-transparent so that the template can be seen through the image. The invention is not intended to be limited to any particular GUI, GUI arrangement, or means to combine the image 30 and template 40.

The user can manipulate the position of the image 30 with respect to the template 40, such as by dragging one of the image 30 or template 40 with respect to the other in the GUI. In this manner the user can align the label template 40 and the electronic image 30 as desired to create the desired label and view screen image. The electronic image 30 can be scaled in size, larger or smaller, with respect to the label template 40. The electronic image 30 can be edited prior to or subsequent to the combination with the label template 40. Editing can include, but is not limited to, adding pictures/clipart, adding text, adding or removing a background, cropping, removing elements, selective color change, noise removal, orientation, perspective correction, image distortion, merging, slicing and/or color adjustments. As mentioned above, the plurality of menus 24 can be used for displaying editing tools.

After combining the electronic image 30 with the label template 40 to the user's satisfaction, the user can use the software to create a view screen electronic image from the portion of the image 30 within template window 42. As discussed above, the creation of the view screen electronic image can be performed manually by framing, cutting or copying, and then saving the image portion within window 42. However, in a preferred embodiment of this invention, the view screen electronic image is created automatically by the software by the user actuating an icon, button, or other suitable means. The software creates an uploadable electronic image of just the image portion in window 42, and desirably automatically uploads the image to the device 10 or sends the new image to a separate application, such as the ITUNES application, for uploading to the electronic device 10. The software may provide the user with a choice of format for the new view screen electronic image, or may operate using a default image format established by the user.

In one embodiment of the invention, the image 30 is then automatically printed on a label corresponding to the label template 40 in the position shown in FIG. 7. The printing step can be done by conventional printers and printing techniques. Referring to FIG. 7, at least a portion 34 of the electronic image 30, which external of window 42 and bordered on an outside by the template boundary 44, will be printed onto the label. The user can desirably control whether to print or exclude from printing parts of the electronic image 30 that are surrounded by the window 42 and/or the shape 46.

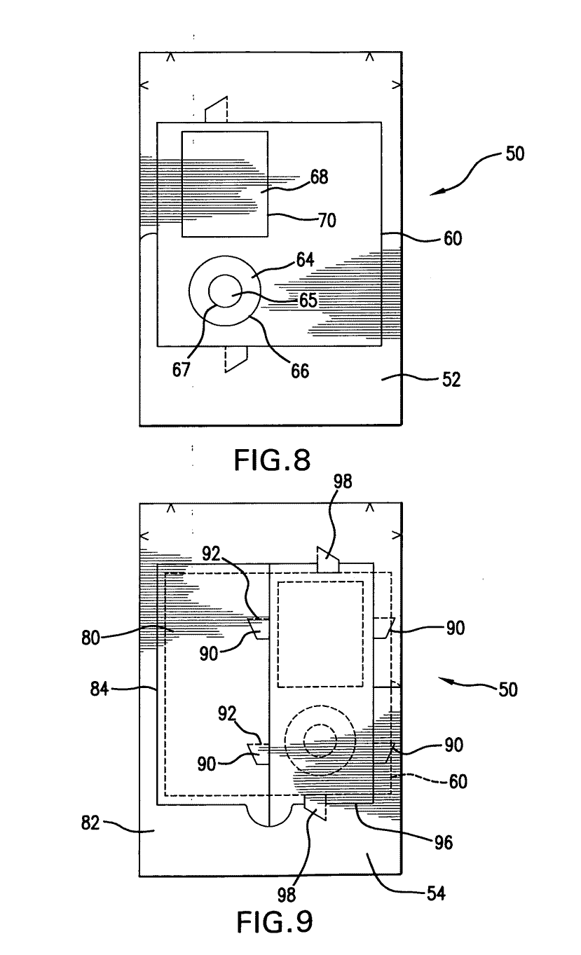

The printed label can then be placed on and adhered to the device by the user, such as by using label assemblies and techniques disclosed in U.S. patent application Ser. Nos. 12/426,816 and 12/426,823, the label structures of which are hereby incorporated by reference. FIGS. 8 and 9 show the front and back, respectively, of a label assembly 50 of one such exemplary label assembly for use in providing the label 20 shown in FIG. 2. Label assembly 50 includes a face sheet 52 having a printed or printable surface, shown in the view of FIG. 8, and an adjacent back sheet 54, shown in the view of FIG. 9. The surface of the face sheet 52 that is disposed toward the back sheet 54, and opposite the printed or printable surface, includes an adhesive material coating. The adhesive coating can include any adhesive material known and available to those skilled in the art for forming pressure sensitive, or self-adhesive, labels. The back sheet 54 is desirably formed of a material to which the adhesive coating adheres significantly less than to the face sheet 52, such as is known for forming pressure sensitive, or self-adhesive, labels.

The face sheet 52 is preferably, but not necessarily, constructed of any suitable paper, paper composite, non-metal and/or metal material that can be used to make pressure sensitive or self-adhesive labels. Such face materials may include, but are not limited to: smudgeproof stock, litho stock, cast coated stock, tag stock, fluorescent stock, foils, computer printable polyester, vinyl, satin cloth, Tyvek™ material, flexible plastic, book papers, photo quality papers and/or photo quality film. Furthermore, various portions of the face materials can be different colors, thereby resulting in different colored parts. Other suitable materials for constructing the sheet 52 include fabric, plastic, and metal foils. The adhesive coating covered by the back sheet is applied to the face sheet 52 in any suitable manner known to those skilled in the art. The face sheet 52 desirably has a printable surface on a side opposite the adhesive coating. The phrase “printable surface” relates to a surface of any type of matter upon which a person or machine can draw, print, color, paint, photocopy, write, emboss, or make any other type of mark or graphic. Laser printers, ink jet printers, impact printers, thermal transfer printers, direct thermal printers, or any other suitable graphic printing devices are preferred but not necessary for use with printing printable surfaces according to this invention. The face sheet can also be pre-printed by the manufacturer or retailer with graphics and/or test desirable to a consumer user. The printed surface can include any desirably image or text, or can be colored or include holographic images.

The label assembly 50 shown in FIGS. 8 and 9 includes a single label shape 60 corresponding to label 20, but could alternatively include two or more. The label shape 60 is defined at an outer periphery by a tearable line of separation 62. As discussed above, the label shape 60 is shown as a label suitable wrapping around a current IPOD® music player as shown in FIG. 2, but the application means of the embodiment of FIGS. 8 and 9 could be applied using other sizes and shapes of label shapes for other devices, such as consumer electronics or and any other object.

The label shape 60 includes additional shapes defined within the periphery by additional tearable lines of separation. The label shape 60 includes two circles 64 and 65 cut within only the face sheet 52 by tearable lines of separation 66 and 67, respectively, which coordinate to the click-wheel and button of the IPOD® player. A rectangular shape 68 is also cut within the face sheet 52 by a tearable line of separation 70 and corresponds to the view screen of the IPOD® player. The tearable lines of the face sheet 52 are shown in phantom in FIG. 9 to illustrate the positioning with the tearable lines and panels of the back sheet 54.

Referring to FIG. 9, the back sheet 54 includes a removable panel 80 defined in the back sheet surface 82 by at least one tearable line of separation 84 extending around the outer periphery of removable panel 80. The removable panel 80 is disposed over a portion, e.g., a majority, of the label shape 60. The removable panel 80 is not exactly coextensive with label shape 60 and extends beyond the label shape 60 on three sides and the label shape 60 extends beyond the removable panel 80 on the fourth side.

The removable panel 80 is divided into two sub-panels, which can assist in applying the label shape 60 to an object, for example, by allowing for only a portion of the removable panel 80 to be removed prior to a first adhesion of the label shape 60 to the object and the subsequent removal or a second panel for wrapping the additional portion of the label shape 60 around a different surface (e.g., a side and/or back surface) of the object. The label assembly 50 includes a registration structure, embodied in FIG. 8 as four spaced apart registration tabs 90 aligned with a portion of the label shape 60. The tabs 90 are each defined on three sides by one or more tearable lines of separation in the back sheet 54. The tabs 90 are raisable to an extended position by folding outward above the back sheet 54. In FIG. 9, fold lines 92 show where the tabs 90 will each desirably be folded, and can a perforated or otherwise scored fold line.

Upon removing the panel portion 96, the device to be labeled can be aligned over the adhesive area that is under the panel portion 96 using the raised registration tabs 90. The label assembly 50 further includes optional alignment tabs 98 similar to tabs 90 and aligned with a portion of the label shape 60 and also one of raised or raisable above the back sheet.

Either the device to be labeled or the label assembly 50 is placed on a surface. The panel portion 96 is removed and the tabs 90 and 98 are raised. When the label assembly 50 is placed face sheet 52 down on the surface, the object is placed over the exposed adhesive material and kept in proper alignment using the tabs 90 and 98. The tabs 90 and 98 align the device over an exposed adhesive on the label shape 60 as the device is lowered onto the object. Once the label shape 60 is partially adhered to the object, the remaining portion of the removable panel 80 is removed, and the surrounding matrix is removed from the label shape 60. The label shape 60 can then be wrapped around the object.

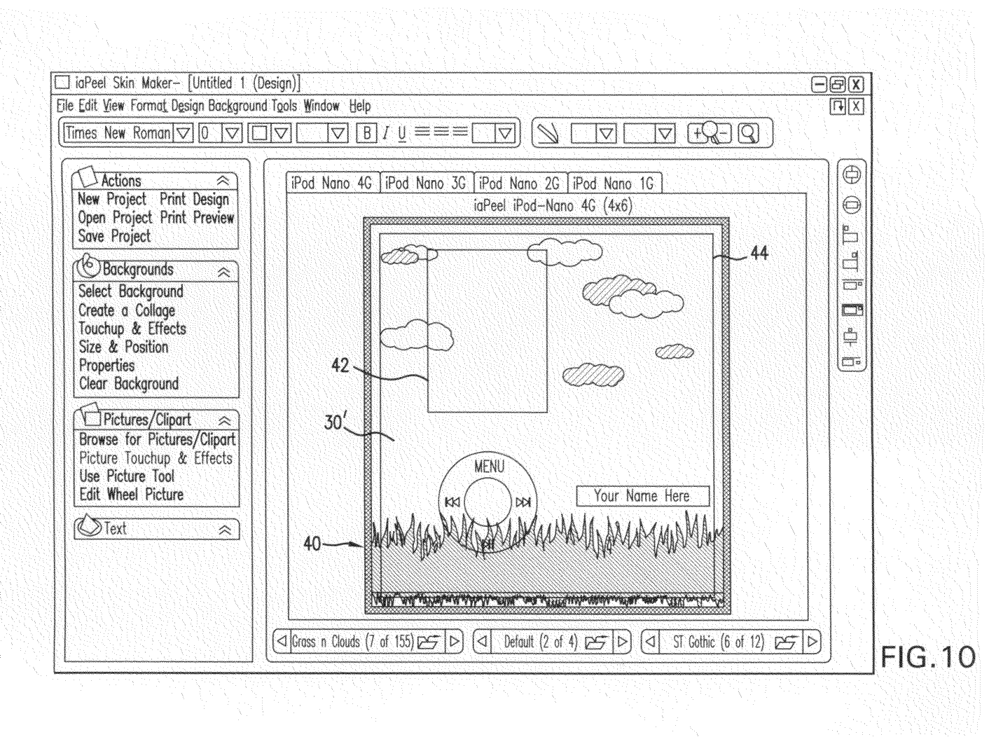

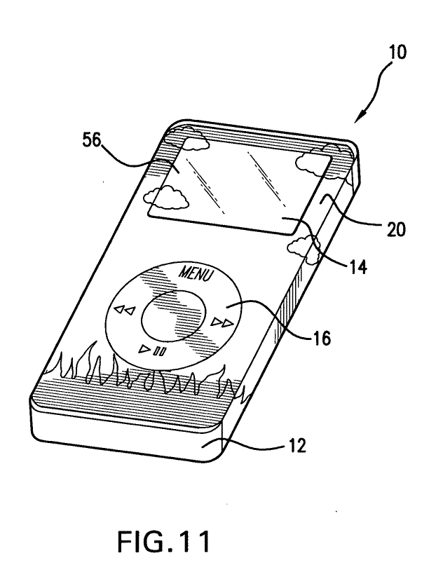

In one embodiment of this invention, the device can be uploaded with two or more images for display on the view screen, where the images are different but both desirably coordinate or match the label on the device. The two different images can desirably work together to create a screen saver functionality for the view screen. FIG. 10, for example, shows an image 30′ that is similar to the image 30 in FIG. 4, except with the sun removed in image 30′. The image 30′ can be a second electronic image or be modified from the electronic image within the GUI shown in FIG. 10. FIG. 11 shows a perspective view of the electronic device 10 with the portion of the image 30′ within the template window 42 displayed as a view screen electronic image 56 on the view screen 14 of device 10. In this embodiment of this invention, the view screen 14 can alternately display the first view screen electronic image 36 and the second view screen electronic image 56. For example, the sun in FIG. 2 or a clear sky of FIG. 11.

The alternating images on the view screen 14 can be used to create movement as well, such as clouds moving across the images discussed above, or the movement of the sun's rays. In an alternative embodiment of this invention, a video can be used to make the label and view screen image. For example, a frame from a video is used to create the electronic digital image for labeling the device and the view screen electronic image comprises a portion of the video that corresponds to view screen window 42. The portion of the video plays on the view screen and corresponds to the portion printed on the label.

Thus, the invention provides a method and software for use by a consumer user to design a custom label as a protective and decorative skin for an electronic or other device. The invention can be used to design and create label skins and/or view screen wallpaper or screen savers. The combination of the printed label and the view screen image can provide a coordinated and near-seamless decoration for an electronic device, one that can even fit under other plastic protective cases. Furthermore, the cost-effective and removable self-adhesive label allows a user to change labels and designs as desired.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

What is claimed is:

1. A method of labeling an electronic device, the method comprising:
positioning an electronic image within a label template displayed in a graphical user interface by a data processor, the label template including a window corresponding to the view screen or feature of the electronic device; and
printing at least a portion of the electronic image on a label corresponding to the label template.

2. The method of claim 1, further comprising editing the electronic image.

3. The method of claim 1, further comprising generating a view screen electronic image from a portion of the electronic image positioned within the window of the label template for upload to the electronic device and display on the view screen of the electronic device.

4. The method of claim 3, further comprising:
generating a second view screen electronic image from the section of the electronic image or a section of a second electronic image positioned within the window of the label template for upload to the electronic device and display on a view screen of the electronic device.

5. The method of claim 4, further comprising creating an alternating display of the view screen electronic image and the second view screen electronic image for the view screen of the electronic device.

6. The method of claim 1, further comprising moving one of the template or the electronic image with respect to an other of the template or the electronic image to change the image portion of the electronic image that coincides with the window.

7. The method of claim 1, wherein the electronic device is one of a cell phone, a portable media player, a gps navigation unit, a handheld game console, a personal digital assistant, an e-book reader, a laptop or a netbook.

8. The method of claim 1, wherein the label comprises a face sheet and an adhesive layer, the face sheet including a printable surface opposite the adhesive layer and formed from a material selected from smudgeproof stock, litho stock, cast coated stock, tag stock, fluorescent stock, foils, computer printable polyester, vinyl, satin cloth, Tyvek™ material, flexible plastic, book papers, photo quality papers, photo quality film, or combinations thereof.

9. The method of claim 3, wherein the electronic image comprises a selected frame from a video.

10. The method of claim 9, further comprising generating a view screen electronic image by cropping a portion of the video to a size approximately equal to the window to form a view screen video for download to the electronic device and display on the view screen and printing the selected frame from the video on the label.

11. The method of claim 1, wherein the label template further comprises a boundary corresponding to an outer dimension of the label for the electronic device.

12. The method of claim 1, wherein the label template further comprises a shape corresponding to the feature of the electronic device.

13. The method of claim 1, further comprising modifying the label template.

14. Software comprising code recorded on a computer readable medium and executable by a data processor for implementing the method of claim 1.

15. A method of labeling an electronic device, the method comprising:
displaying a label template selected by a user in a graphical user interface generated by a data processor, the label template including a boundary corresponding to a label for the electronic device and a window within the boundary corresponding to a view screen of the electronic device;
accessing an electronic image with the graphical user interface;
positioning the electronic image with respect to the label template displayed in the graphical user interface;
generating a view screen electronic image from a portion of the electronic image positioned within the window for upload to the electronic device and display on the view screen; and
printing a portion of the electronic image that is positioned between the boundary and the window on the label.

16. The method of claim 15, automatically sending the view screen electronic image to an upload queue of the electronic device.

17. Software for labeling an electronic device and including code stored on a recordable medium and for execution on a data processor, the software comprising:
instructions for combining a label template and an electronic image within a graphical user interface, the label template including a boundary and a window within the boundary;
commands for generating a view screen electronic image by extracting a section of the electronic image positioned within the window within the graphical user interface for upload to the electronic device and display on the view screen; and
commands for sending at least a portion of the electronic image bordered by the boundary to a printer in communication with the data processor for printing.

18. The software of claim 17, further comprising instructions for automatically saving and sending the view screen electronic image to an upload queue for the electronic device.

19. The software of claim 17, further comprising commands for moving one of the electronic image or the label template with respect to an other of the electronic image or the label template to change the portion of the electronic image positioned within the window.

20. The software of claim 17, further comprising commands for editing the electronic image or generating a second electronic image within the window of the label template.
